(19) United States
(12) Patent Application Publication
(10) Pub. No.: US 2014/0029437 A1
(43) Pub. Date: Jan. 30, 2014

(54) INFORMATION PROCESSING SYSTEM, INFORMATION PROCESSING METHOD, AND RELAY APPARATUS

(71) Applicant: FUJITSU LIMITED, Kawasaki-shi (JP)

(72) Inventors: Toshihiko Kurita, Kawasaki (JP); Shinji Yamashita, Kawasaki (JP); Hideki Mitsunobu, Kawasaki (JP)

(73) Assignee: FUJITSU LIMITED, Kawasaki-shi (JP)

(21) Appl. No.: 13/865,569

(22) Filed: Apr. 18, 2013

(30) Foreign Application Priority Data
Jul. 24, 2012 (JP) 2012-163679

(51) Int. Cl. H04L 12/803

(52) U.S. Cl. CPC H04L 47/122
USPC 370/237

(57) ABSTRACT

An information processing system includes a relay apparatus configured to select a first route by an operation on the basis of a first address in a packet, and a computer configured to change, when congestion occurs in the first route, an address in the packet from the first address to a second address which causes the relay apparatus to select a second route having a destination the same as that of the first route by the operation.

### CROSS-REFERENCE TO RELATED APPLICATION

This application is based upon and claims the benefit of priority of the prior Japanese Patent Application No. 2012-163679, filed on Jul. 24, 2012, the entire contents of which are incorporated herein by reference.

### FIELD

The embodiment discussed herein is related to an information processing system, an information processing method, and a relay apparatus.

### BACKGROUND

A spanning tree protocol (STP) used for a layer 2 (which will be hereinafter referred to as an “L2”) network connecting servers within a data center is a technique in which a blocking port is set in a relay apparatus provided in the network so that a loop is not formed in the L2 network. However, use of a part of a route in the network is restricted by setting the blocking port, and therefore, a network bandwidth is not effectively utilized.

With the recent increase in the traffic of data center networks, in order to effectively utilize a network bandwidth, efforts have been made to internationally standardize a multipath technique used for the L2 network. As one of such multipath techniques, transparent interconnection of lots of links (TRILL) which is a technique developed with consideration given to loop avoidance in the L2 network for connecting servers has been examined.

FIG. 1 illustrates an example information processing system to which the TRILL is applied. The example information processing system includes a network including six routing bridges (which will be hereinafter referred to as “RBs”), and four servers (which will be hereinafter referred to as “SVs”) connected to the network. In some cases, among the six RBs, an RB connected to an external apparatus (for example, an SV) for the network is called an edge routing bridge (which will be hereinafter referred to as an “edge RB”). The connection between RBs is considered as a link, and the six RBs are connected with one another, thereby forming a plurality of links in the network. A parameter called a link cost is set for the link. The connection between RBs is called a route, and the total of link costs set for links provided on the route is set as a total link cost. When there are a plurality of routes which are selectable for inter-SV transfer, the route having the smallest total link cost is selected. When there are a plurality of routes having the smallest total link cost, the plurality of routes are selected such that a frequency with which a route is selected since the start of the selection of the plurality of routes is the same for the routes, and thus, the load on the network is decentralized.

Note that a method in which, when there are a plurality of routes having the smallest total link cost, a route is selected by performing a hashing operation on the basis of an address included in a packet is known.

“BCEFE in a Nutshell Study Guide for Exam 150-620,” Revision 0312, Brocade Communications Systems Inc. <http://www.brocade.com/downloads/documents/certification_study_tools/bcefe-nutshell.pdf> (Accessed Jun. 15, 2012) is an example of the related art.

### SUMMARY

According to an aspect of the invention, an information processing system includes a relay apparatus configured to select a first route by an operation on the basis of a first address in a packet, and a computer configured to change, when congestion occurs in the first route, an address in the packet from the first address to a second address which causes the relay apparatus to select a second route having a destination the same as that of the first route by the operation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example information processing system to which the related art is applied.

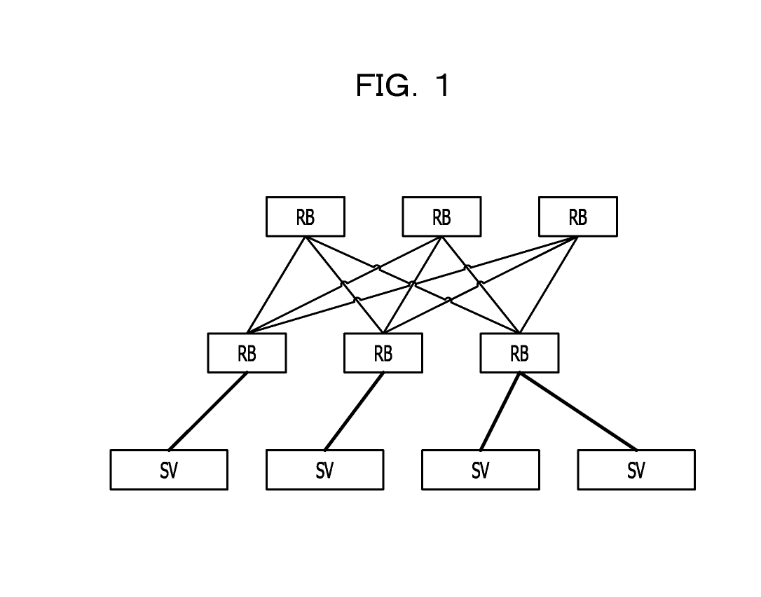

FIG. 2 illustrates an information processing system to which an embodiment is applied.

FIG. 3 illustrates a hardware configuration of a routing bridge to which the embodiment is applied.

FIG. 4 illustrates a functional block of a routing bridge to which the embodiment is applied.

FIG. 5 illustrates a part of cost information of a network to which the embodiment is applied.

FIG. 6 illustrates another part of the cost information of the network to which the embodiment is applied.

FIG. 7 illustrates a route table of a routing bridge to which the embodiment is applied.

FIGS. 8A and 8B each illustrate a packet configuration example that is processed by an information processing system to which the embodiment is applied.

FIG. 9 illustrates another functional block of a routing bridge to which the embodiment is applied.

FIG. 10 illustrates processing that is to be executed by a routing bridge to which the embodiment is applied.

FIG. 11 illustrates another functional block of a routing bridge to which the embodiment is applied.

FIG. 12 illustrates a hardware configuration of a management server to which the embodiment is applied.

FIG. 13 illustrates a functional block of a management server to which the embodiment is applied.

FIG. 14 illustrates processing that is to be executed by a management server to which the embodiment is applied.

FIG. 15 illustrates address conversion information according to the embodiment.

FIG. 16 illustrates another processing that is to be executed by a management server to which the embodiment is applied.

FIG. 17 illustrates another processing that is to be executed by a management server to which the embodiment is applied.

FIG. 18 illustrates a functional block of a management server to which the embodiment is applied.

FIG. 19 illustrates another processing that is to be executed by a management server to which the embodiment is applied.

FIG. 20 illustrates a hardware configuration of a server to which the embodiment is applied.

FIG. 21 illustrates a functional block of a server to which the embodiment is applied.

FIG. 22 illustrates a route table of a server to which the embodiment is applied.

FIG. 23 illustrates transmission processing executed by a server to which the embodiment is applied.

FIG. 24 illustrates reception processing executed by a server to which the embodiment is applied.

FIG. 25 illustrates an example processing of an information processing system to which the embodiment is applied.

FIG. 26 illustrates an example processing of an information processing system to which the embodiment is applied.

### DESCRIPTION OF EMBODIMENT

First, the following was found by examinations conducted by the present inventor. With a route allocated in accordance with an address in a packet, even when congestion occurs in a network, the route in which the congestion has occurred is continuously allocated for communication of the address via the route in which the congestion has occurred, and the congestion is not recovered.

According to an embodiment, when congestion occurs in a network in which a route is selected by an operation on the basis of an address in a packet, the address in the packet is changed such that a destination is not changed. Thus, the route in which congestion has occurred may be bypassed without changing an algorithm of the operation used for selecting a route, thereby recovering the congestion.

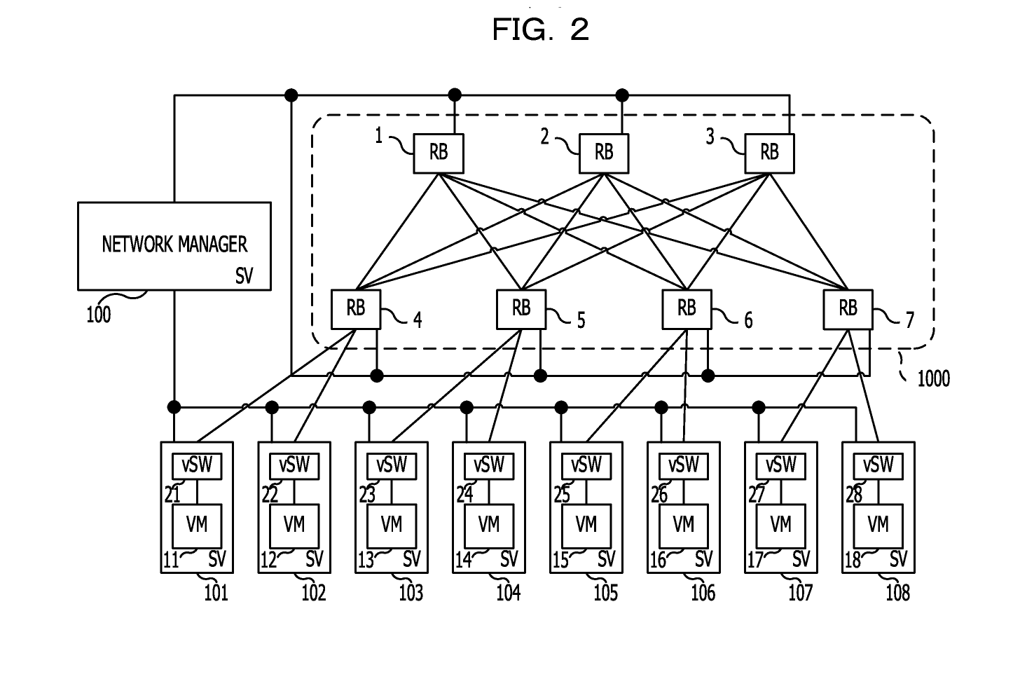

FIG. 2 illustrates an information processing system to which the embodiment is applied. The information processing system includes a network 1000, servers (which will be hereinafter referred to as “SVs”) 100 to 108, and routing bridges (which will be hereinafter referred to as “RBs) 1 to 7. The RBs 1 to 7 are included in the network 1000.

The SV 100 is connected to the SVs 101 to 108 and the RBs 1 to 7. The SV 100 is a management server that manages the information processing system.

In the SV 101, a virtual machine 11 and a virtual switch 21 are executed (a virtual machine and a virtual switch will be hereinafter referred to as a “VM” and a “vSW,” respectively). The VM 11 transfers data to the RB 4 via the vSW 21. As illustrated in FIG. 2, the SVs 102 to 108 are connected to the RBs 4 to 7. The VMs 12 to 18 that are executed by the SVs 102 to 108 transfer data to the RBs 4 to 7 connected thereto via the vSW 22 to 28. Note that, the number of VMs executed by a single SV may be a plural number.

The RBs 1 to 7 are relay apparatuses that change a route used for data transfer between the SVs 101 to 108 by switching. The RBs 1 to 3 are end of row (EOR) switches, and the RBs 4 to 7 are top of rack (TOR) switches. The RBs 1 to 7 are connected to one another in a relationship illustrated in the network 1000 of FIG. 2. Note that a connection relationship other than the relationship illustrated in FIG. 2 may be applied as the connection relationship of the RBs 1 to 7.

The connection between RBs is called a link, and a link ID is given to the link. A parameter called a link cost is set for the link.

There might be cases where, among the RBs 1 to 7, an RB connected to an external apparatus (for example, SVs 101 to 108) for the network 1000 is called an edge routing bridge (which will be hereinafter referred to as an “edge RB”). The connection between edge RBs is called a route, and a route ID is given to the route. The route may include a plurality of links, and the total of the link costs of all the links included in the route is set as a parameter called total link cost for the route. The RBs 1 to 7 are connected to one another, thereby forming a plurality of routes between the SVs 101 to 108. Which route, among the plurality of routes, is to be selected as a route used for data transfer between the SVs 101 to 108 is determined by comparing total link costs set for the plurality of routes. For example, the route having the small total link cost is selected as a route used for data transfer.

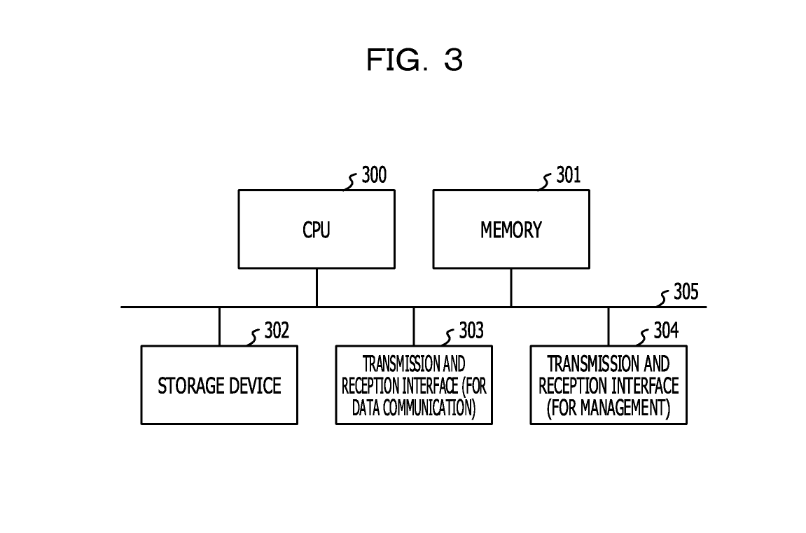

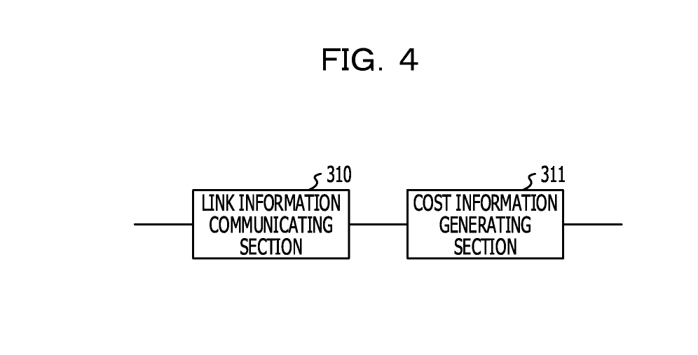

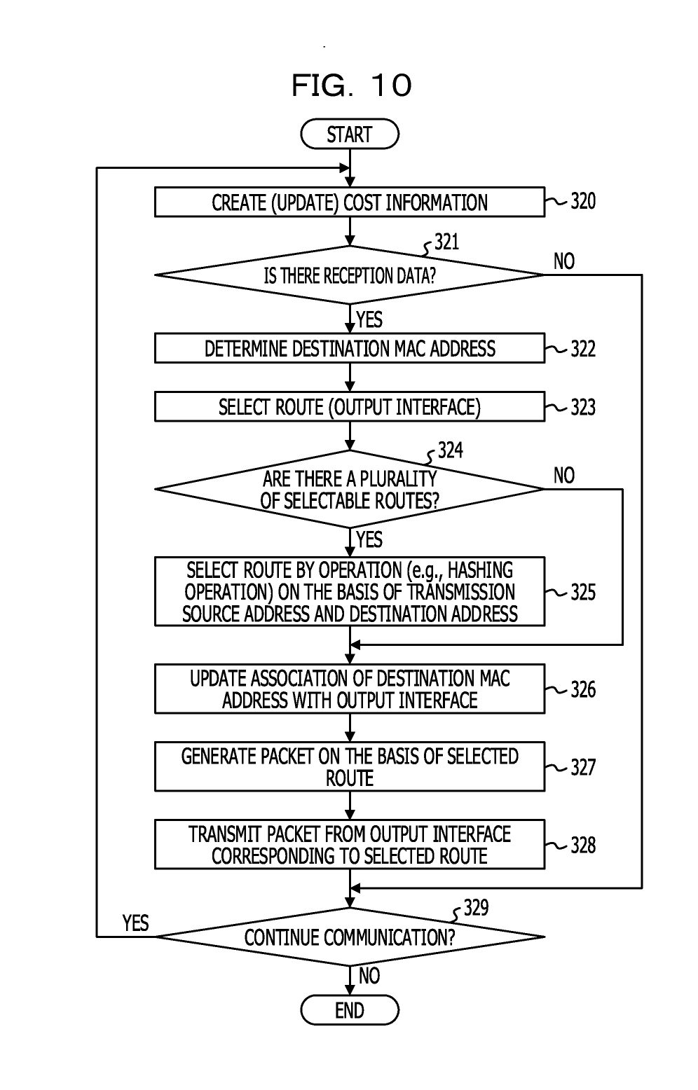

FIG. 3 illustrates a hardware configuration of the routing bridge to which the embodiment is applied. Each of the RBs 1 to 7 is a relay apparatus including a CPU 300, a memory 301, a storage unit 302, a transmission and reception interface (for data communication) 303, a transmission and reception interface (for management) 304, and a bus 305 to which these components are connected. The CPU 300 includes one or more processors that execute processing. The memory 301 is, for example, a RAM. The storage unit 302 is, for example, a nonvolatile memory such as a ROM, a flash memory, or the like, or a magnetic disk such as a hard disk drive (HDD) or the like. The transmission and reception interface (for data communication) 303 is an interface used for transmitting and receiving data to and from an external apparatus. The transmission and reception interface (for management) 304 is an interface used for transmitting and receiving data used for management. A program in which processing that controls the operation of each of the RBs 1 to 7 is written and a program in which processing illustrated in FIG. 10 is written are stored in the memory 301. By executing the programs stored in the memory 301 by the CPU 300, the RBs 1 to 7 function as functional blocks illustrated in FIGS. 4, 9, and 11.

FIG. 4 illustrates a functional block of a routing bridge to which the embodiment is applied. By executing the programs stored in the memory 301 by the CPU 300, the RBs 1 to 7 function as a link information communication section 310 and a cost information generation section 311.

Each of the RBs 1 to 7 is configured such that the link ID and the link cost for a link connected to the RB is stored in the memory 301 in advance. Note that the link ID and the link cost may be set from the SV 100 provided outside the RBs 1 to 7. IDs of RBs provided at both ends of the link are associated with the link ID. Each of the RBs 4 to 7 is configured to detect log information used for data transfer and the SV and the VM which are connected to the RB, thereby determining the RB as an edge RB and SV and VM connected to the RB.

The link information communication section 310 of each of the RBs 1 to 7 broadcasts the link information including the link ID, the IDs of RBs provided at both ends of the link and the link cost of the link which have been stored in the memory 301 in advance to the other RBs. The link information communication section 310 obtains the link information including the link IDs, the IDs of RBs provided at both ends of the link and the link cost of the link which have been broadcasted from the other RBs, and stores the obtained link information in the memory 301. By the above-described processing of the link information communication section 310, each of the RBs 1 to 7 obtains the link information including the link IDs of links which are not directly connected to the RB, the IDs of RBs provided at both ends of the link, and the link cost of the link. Note that, when the link IDs overlap, an RB serving as a representative may be determined among the RBs 1 to 7, and the representative RB may perform mediation to determine the link ID uniquely.

The link information communication section 310 of each of the edge RBs 4 to 7 broadcasts information that the RB is the edge RB and information regarding the SVs and VMs which are connected to the RB to the other RBs. The link information communication section 310 obtains information regarding an edge RB broadcasted from the other RBs, thereby determining which RB is an edge RB in the network 1000.

For example, the RB 1 and the RB 4 illustrated in FIG. 2 are connected to each other, and the link ID of a link having the RB 1 and the RB 4 at both ends is LK1. Also, the RB 1 is connected to the RB 5 via a link LK2, the RB 1 is connected to the RB 6 via link LK3, and the RB 1 is connected to the RB 7 via a link LK4. Since the RB 1 is connected to the link LK1, the link LK2, the link LK3, and the link LK4, the IDs of the RBs provided at both ends of each of the link LK1, the link LK2, the link LK3, and the link LK4 and the link cost for each of the link LK1, the link LK2, the link LK3, and the link LK4 are stored in the memory 301 in advance. The RB 1 broadcasts the link IDs of the link LK1, the link LK2, the link LK3, and the link LK4, the IDs of the RBs provided at both ends of each of the link LK1, the link LK2, the link LK3, and the link LK4 and the link cost for each of the link LK1, the link LK2, the link LK3, and the link LK4 to the RBs 4 to 7, and thus, for example, the RB 5 obtains the link IDs of the link LK1, the link LK3 and the link LK4, the IDs of the RBs provided at both ends of each of the link LK1, the link LK3 and the link LK4, and the link cost for each of the link LK1, the link LK3 and the link LK4, and stores them in the memory 301 of the RB 5.

Each of the RBs 1 to 7 specifies transfer data as a flow on the basis of a combination for VMs included in a packet that is to be transferred (a combination of a media access control (MAC) address of a transmission source VM and a MAC address of a destination VM), associates a route allocated to the flow with the flow, and stores the route and the flow as forwarding information in the memory 301.

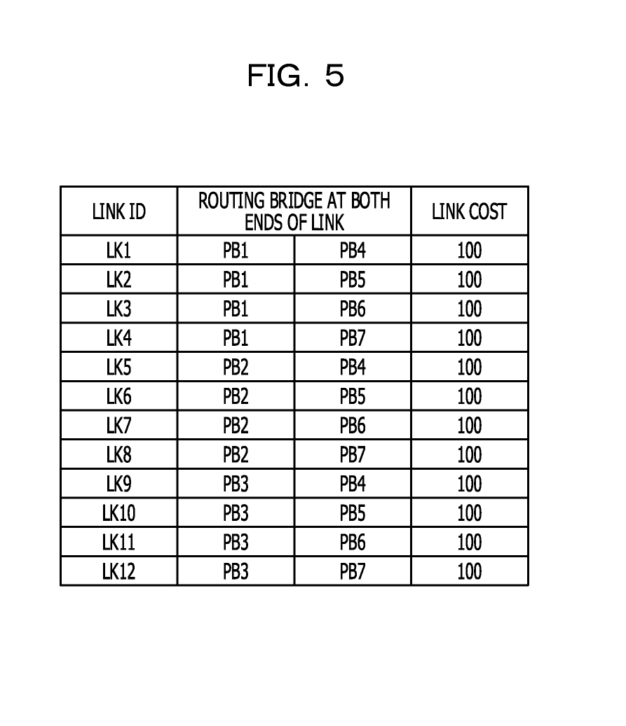

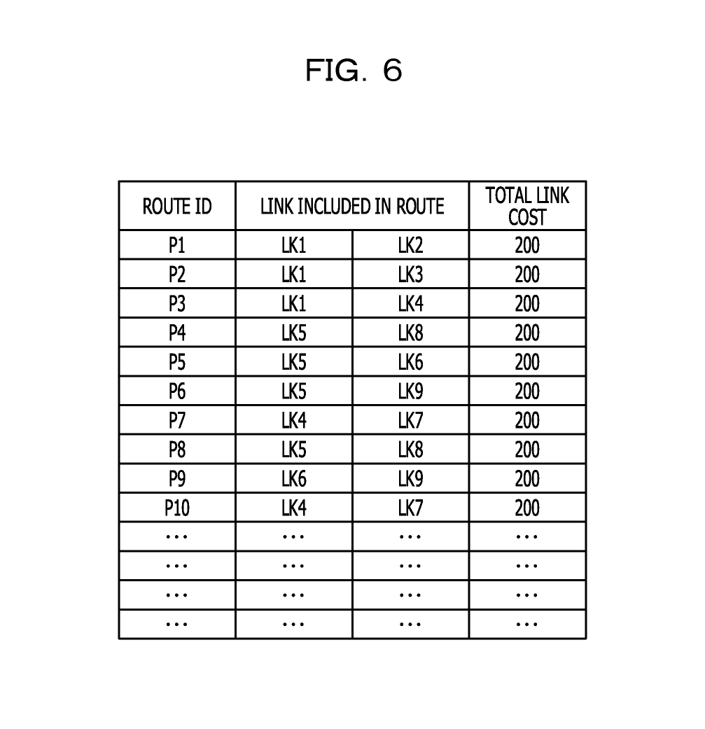

The cost information generation section 311 of each of the RBs 1 to 7 stores, as a part of the cost information, association of the link IDs of links included in the network 1000, the IDs of RBs provided at both ends of each of the links, and the link costs of the links in the memory 301 on the basis of the link ID, the IDs of RBs provided at both ends of the link and the link cost of the link which have been stored in the memory 301 in advance, the link IDs, the IDs of RBs provided at both ends of each of the other links and the link costs of the links which have been obtained from the other RBs, and the forwarding information. The cost information generation section 311 of each of the RBs 1 to 7 stores, as a part of the cost information, association of the route ID and the total link cost included in the network 1000 in the memory 301 on the basis of the IDs of RBs provided at both ends of a corresponding link and a corresponding edge RB. By the above-described processing of the cost information generation section 311, each of the RBs 1 to 7 stores the cost information illustrated in FIGS. 5 and 6, which will be described later, in the memory 301.

FIG. 5 illustrates a part of the cost information of the network to which the embodiment is applied. The links LK1 to LK12 serving as the link IDs used for identifying links between the RBs are associated for each of the RBs provided at both ends of each of the links. For example, LK1 is allocated as a link ID to the link having the RB 1 and the RB 4 at both ends.

The link cost that is set in association with the link ID is a parameter value indicating a logical distance of a link. The smaller the logical distance of the link is, the more efficient the data transfer is determined to be. For example, for a link having a link cost smaller than link costs set for the other links, it is determined that highly efficient data transfer may be performed via the link, and the link is selected as a link used for transferring data. Note that FIG. 5 illustrates a case where, assuming that a bandwidth of each of the links LK1 to LK12 is 10 Gbps, the link costs of the links LK1 to LK12 are all the same, that is, 100. Thus, if, when a link cost is determined, bandwidths of target links are all the same, the same link cost may be set. If, even when bandwidths of target links are different, it is preferable to select links at the same frequency, the same link cost may be set for the target links. Note that the embodiment is not limited to the case where the bandwidth of the links LK1 to LK12 is 10 GPs.

FIG. 6 illustrates another part of the cost information of the network to which the embodiment is applied. Route IDs, that is, P1 to P9 identifying routes between edge RBs are associated with the link IDs of all the links included in the routes. For example, P1 is allocated as the route ID to a route including the links LK1 and LK2. Referring to FIG. 5, the link cost set for the link LK1 is 100, and the link cost set for the link LK2 is 100. Therefore, the total of the link costs of all the links included in the route P1 is 200, and the total link cost for the route P1 is set to be 200.

The total link cost set in association with the link ID illustrated in FIG. 6 is a parameter value indicating a logical distance of a route. The smaller the logical distance of the route is, the more efficient the data transfer is determined to be. For example, among the combinations of the total link costs set in association with the route IDs, for a route having a total link cost smaller than total link costs set for the other routes, it is determined that the efficiency of data transfer via the route is high, and the route is selected as a route used for transferring data. In FIG. 6, combinations of the total link costs of the routes P1 to P10 which are some of the routes included in the network 1000 are illustrated as representative combinations and, in this example, the total link costs of the routes P1 to P10 are all the same, that is, 200. Note that, similarly, the total link costs are 200 for the other routes. Description of the other routes would be redundant and is thus omitted.

When there are a plurality of routes for which the smallest total link cost is set, as will be described later, an algorithm which causes the plurality of routes to be selected at the same frequency is applied. For example, a round-robin method may be applied to select a route which has been selected the least. In this case, when there are a plurality of routes for which the smallest total link cost is set, one of the routes is selected by a hashing operation in which the MAC address of the transmission source VM and the MAC address of the destination VM are used as variants. Note that, data transfer is performed in units of packets, and therefore, when the round-robin method is applied, route selection is performed for each packet and a different route is selected for each packet. Accordingly, there might be cases where, when the round-robin method is applied, the order of packets is changed. On the other hand, when the hashing operation is applied, even for different packets, the same route is selected if the MAC address of the transmission source VM and the MAC address of the destination VM are the same. Thus, the order of the packets is not basically changed. Therefore, when the hashing operation is used for selecting a route, a load of the network is decentralized, and the order of packets is maintained.

Note that, in FIGS. 5 and 6, the cost information for a part of a route having two or the edges RBs 4 to 7 at both ends, but the embodiment is not limited thereto. The cost information may be generated for other selectable routes provided in the network 1000. Also, instead of the RBs 1 to 7, the cost information generation section 311 of an RB serving as a representative RB among the RBs 1 to 7 may generate the cost information by obtaining the link information from the other RBs and broadcast the cost information to the other RBs.

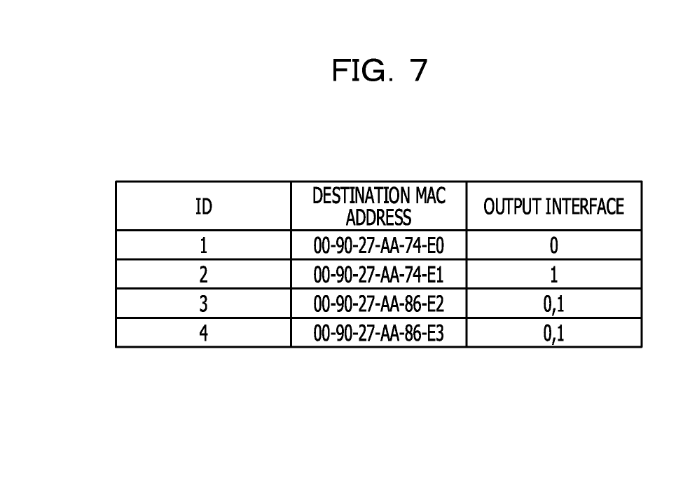

FIG. 7 illustrates a route table of a routing bridge to which the embodiment is applied. For example, when a packet having the destination MAC address of “00-90-27-BB-86-E2” is received, the total link cost of selectable routes is referred to, and it is determined that a plurality of routes are selectable. In the route table, output interfaces corresponding to the determined plurality of routes are identified by “0” and “1” and it is determined that a packet may be outputted to one of the output interfaces. As described above, when there are a plurality of selectable routes, the hashing operation on the basis of the MAC address is applied to determine a route, one of the output interfaces “0” and “1” is selected, and the packet is transmitted.

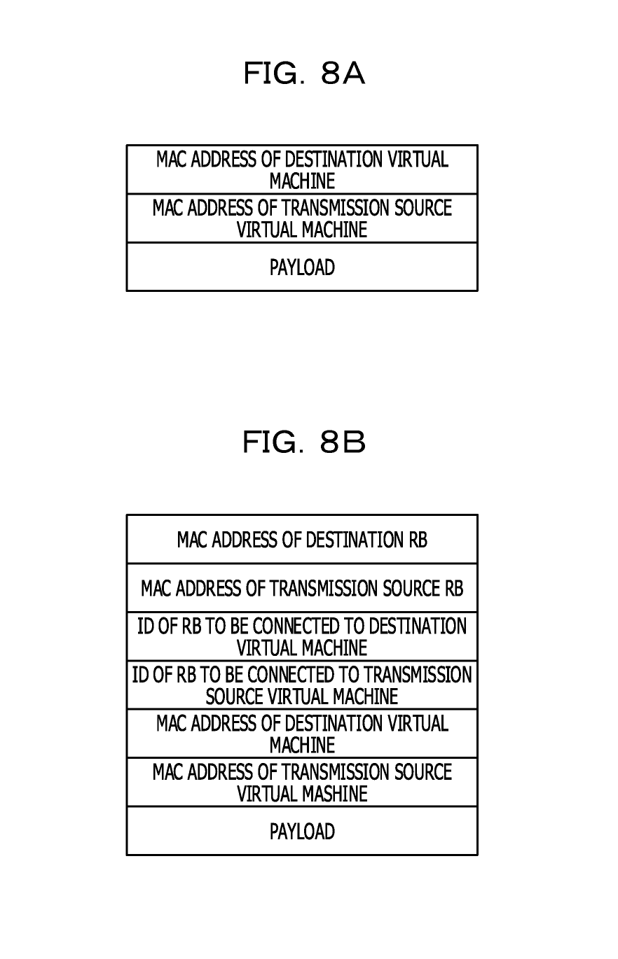

FIGS. 8A and 8B each illustrate an example packet processed by the information processing system to which the embodiment is applied. FIG. 8A illustrates a first configuration example of the packet processed by the information processing system to which the embodiment is applied, and FIG. 8B illustrates a second configuration example of the packet processed by the information processing system to which the embodiment is applied. When transmitting data, as illustrated in FIG. 8A, each of the SVs 101 to 108 transmits a packet including at least a payload, the MAC address of a transmission source VM, and the MAC address of a destination VM. When receiving the packet illustrated in FIG. 8A, each of the RBs 1 to 7 specifies an edge RB to which the destination VM is connected on the basis of the MAC address of the transmission source VM, the MAC address of the destination VM, and the cost information and the forwarding information stored in the memory 301. When the edge RB to which the destination VM is connected is specified, the ID of an RB connected to the transmission source VM and the ID of an RB connected to the destination VM are added to the packet illustrated in FIG. 8A. Furthermore, when a route used for data transfer is selected by processing, which will be described later, the RB adds the MAC address of the RB itself as the MAC address of the transmission source, and the MAC address of an RB that is to be the next destination on the route used for data transfer as the MAC address of the destination RB to data illustrated in FIG. 8A. By the above-described processing, each of the RBs 1 to 7 encapsulates the received packet as a packet illustrated in FIG. 8B, and transfers the encapsulated packet to an RB that is to be the next destination. Data transfer between RBs is executed in accordance with a route selection for data transfer, which will be described later, while rewriting the MAC address of the transmission source RB and the MAC address of the destination RB illustrated in FIG. 8B. Since the transfer destination that is to be the next destination is the destination VM, when receiving data, an RB connected to the destination VM de-encapsulates the packet illustrated in FIG. 8B, converts the configuration of the packet to a packet configuration illustrated in FIG. 8A, and then, transfers the converted packet to the destination VM. Note that, when each of the SVs 101 to 108 and the RBs 1 to 7 does not store the MAC address of the destination in advance, the MAC address of the destination may be obtained using an address resolution protocol (ARP).

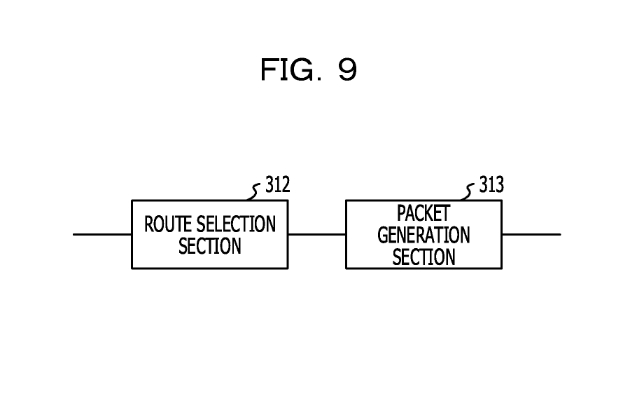

FIG. 9 illustrates another functional block of the routing bridge to which the embodiment is applied. By executing the program stored in the memory 301 by the CPU 300, each of the RBs 1 to 7 functions as a route selection section 312 and a packet generation section 313. Processing executed by each functional block will be described later in correspondence with processing illustrated in FIG. 10.

FIG. 10 illustrates processing executed by the routing bridge to which the embodiment is applied. In each of the RBs 1 to 7, the program stored in the memory 301 is executed by the CPU 300, and thus, each processing illustrated in FIG. 10 is executed.

Step 320 of creating (updating) the cost information illustrated in FIGS. 5 and 6 is executed by the cost information generation section 311. An example of processing of creating the cost information is as described above.

Step 321 of determining whether or not there is reception data is executed by the RBs 1 to 7. If there is no reception data, the process proceeds to Step 329. If there is reception data, the process proceeds to Step 322.

Step 322 of determining the MAC address of the destination VM included in a received packet is executed by the route selection section 312. Step 323 of selecting a route (the output interface) on the basis of the MAC address of the determined destination VM is executed by the route selection section 312. In the route table illustrated in FIG. 7, if the MAC address of the determined destination VM has been already associated with the output interface, a route (the output interface) is selected in accordance with the association. In the route table illustrated in FIG. 7, if the MAC address of the determined destination VM is not associated with the output interface, the route having the smallest total link cost is selected among selectable routes extending to the destination VM in accordance with the cost information illustrated in FIG. 6. As a result of the Step 323, Step 324 of determining whether or not there are a plurality of selectable routes is executed by the route selection section 312. If there are not a plurality of selectable routes, the process proceeds to Step 326. If there are a plurality of prospective routes, the process proceeds to Step 325.

Step 325 of selecting a route by an operation on the basis of the transmission source address and the destination address is executed by the route selection section 312. For example, the hashing operation in which the MAC address of the transmission source VM and the MAC address of the destination VM are variants is executed, and thus, a route corresponding to an obtained hash value is selected among the selectable routes. Note that a hash coefficient used in the hashing operation is stored in the memory 301.

Step 326 of updating association of the destination MAC address with the output interface is executed by the route selection section 312. Association of the output interface corresponding to the route selected in Step 325 with the MAC address of the destination VM is updated in the route table illustrated in FIG. 7. The updated route table is stored with the above-described forwarding information, as log information for data transfer, in the memory 301.

Step 327 of generating a packet on the basis of the selected route is executed by the packet generation section 313. A packet configuration and a method for generating a packet are as described regarding FIGS. 8A and 8B. Next, Step 328 of transmitting a packet from the output interface corresponding to the selected route is executed. Subsequently, Step 329 regarding whether or not communication is to be continued is executed by the RBs 1 to 7. If communication is to be continued, the process proceeds to Step 320, and if communication is not to be continued, the process is ended.

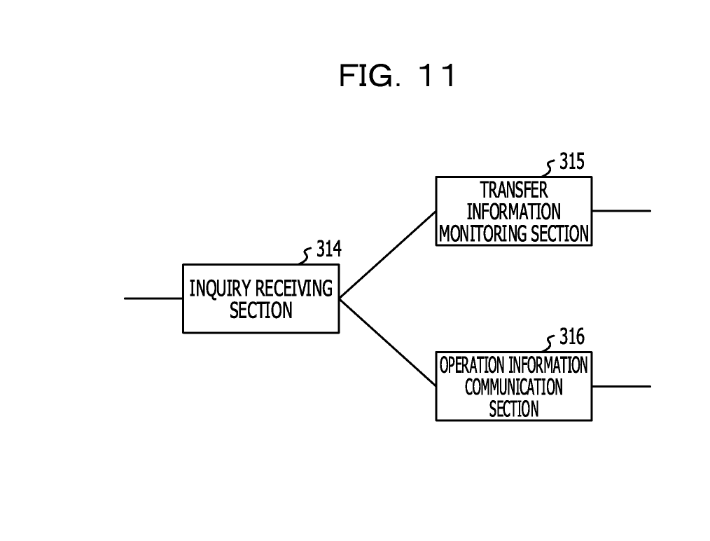

FIG. 11 illustrates another functional block of the routing bridge to which the embodiment is applied. By executing the program stored in the memory 301 by the CPU 300, each of the RBs 1 to 7 functions as an inquiry receiving section 314, a transfer information monitoring section 315, and an operation information communication section 316. The inquiry receiving section 314 receives an inquiry for detecting congestion in the network 1000 from the SV 100. Furthermore, the inquiry receiving section 314 receives an inquiry for a parameter (for example, the hash coefficient) regarding an operation used for selecting a route from the SV 100. When the inquiry receiving section 314 receives an inquiry, the transfer information monitoring section 315 monitors an amount of data stored in an input buffer or an output buffer included in the transmission and reception interfaces 303 and 304 or a free space of the input buffer or the output buffer, and transmits a monitoring result as transfer information to the SV 100. When the inquiry receiving section 314 receives an inquiry, the operation information communication section 316 transmits the hash coefficient stored in the memory 301 as operation information to the SV 100.

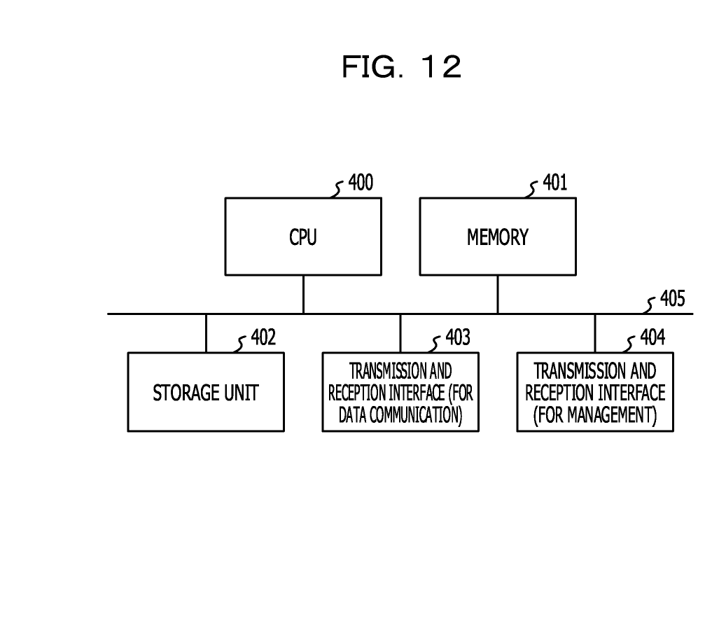

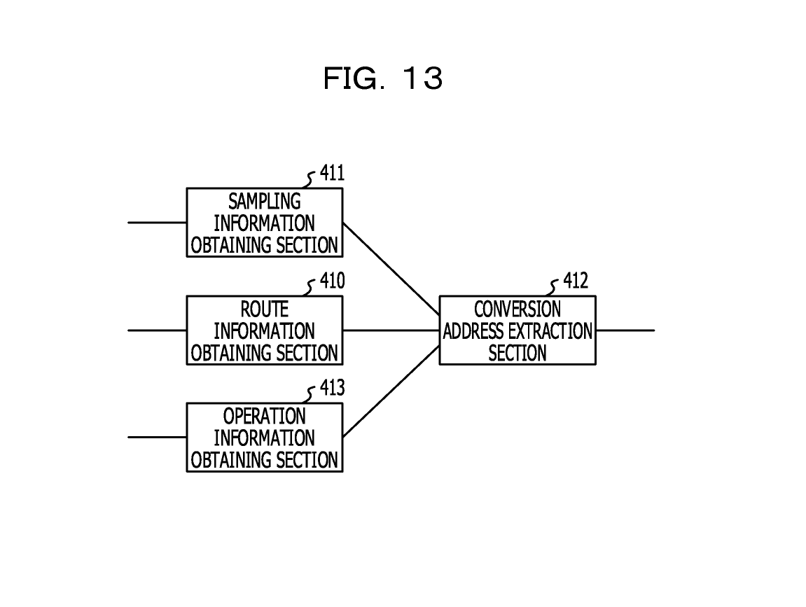

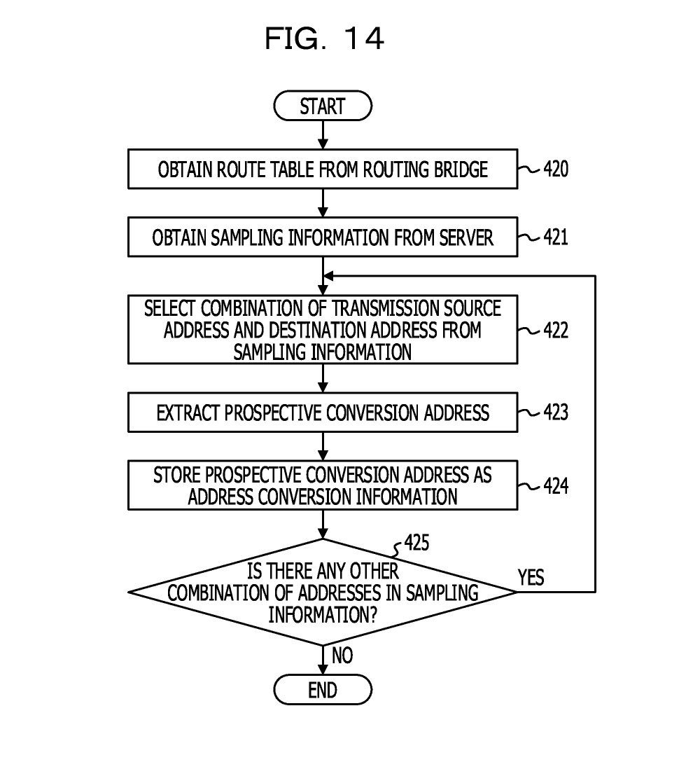

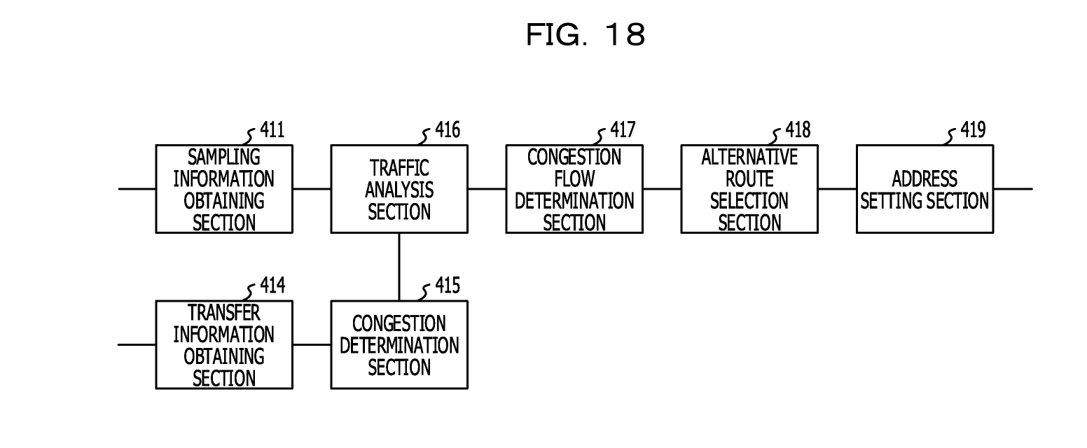

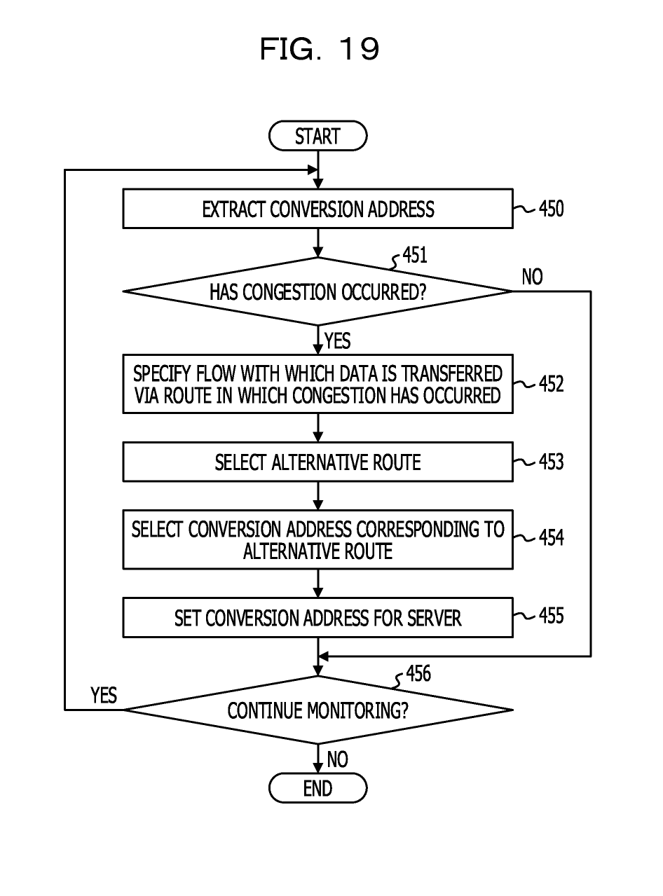

FIG. 12 illustrates a hardware configuration of the management server (the SV 100) to which the embodiment is applied. The SV 100 is a computer including a CPU 400, a memory 401, a storage unit 402, a transmission and reception interface (for data communication) 403, a transmission and reception interface (for management) 404, and a bus 405 to which these components are connected. The CPU 400 includes one or more processors that execute processing. The memory 401 is, for example, a RAM. The storage unit 402 is, for example, a nonvolatile memory such as a ROM, a flash memory, and so forth, or a magnetic disk such as a hard disk drive (HDD) and so forth. The transmission and reception interface (for data communication) 403 is an interface used for transmitting and receiving data to and from an external apparatus. The transmission and reception interface (for management) 404 is an interface used for transmitting and receiving data used for management. A program in which processing that controls the operation of the SV 100 is written, a program in which processing illustrated in FIG. 14, 16, or 17, and a program in which processing illustrated in FIG. 19 are stored in the memory 401. By executing the programs stored in the memory 401 by the CPU 400, the operation of the SV 100 is controlled and the SV 100 functions as functional blocks illustrated in FIGS. 13 and 18.

FIG. 13 illustrates a functional block executed by the management server (the SV 100) to which the embodiment is applied. By executing the programs stored in the memory 401 by the CPU 400, the SV 100 functions as a route information obtaining section 410, a sampling information obtaining section 411, a conversion address extraction section 412, and an operation information obtaining section 413. Processing executed by each functional block will be described in correspondence with processing illustrated in FIGS. 14, 16, and 17.

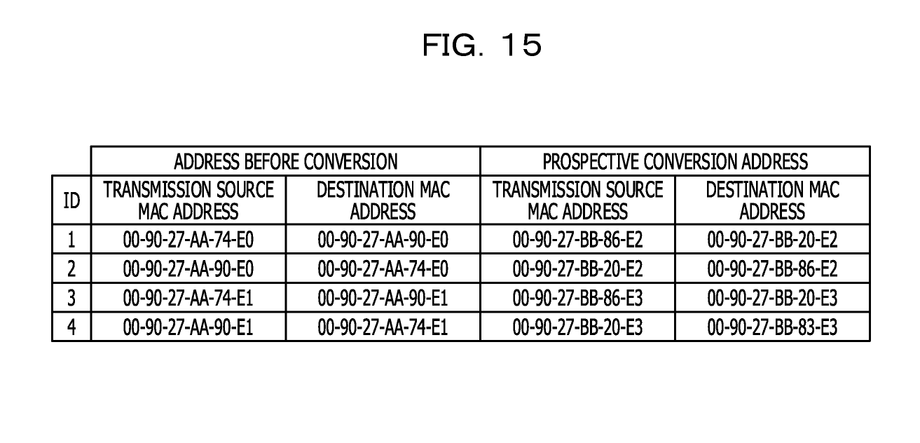

FIG. 14 illustrates processing executed by the management server (the SV 100) to which the embodiment is applied. The processing illustrated in FIG. 14 is processing performed for causing the SV 100 to obtain address conversion information illustrated in FIG. 15.

Step 420 of obtaining route information from each of the RBs 1 to 7 is executed by the route information obtaining section 410. By Step 420, the SV 100 obtains the above-described log information as route information from each of the RBs 1 to 7. As described above, the log information includes the route table and the forwarding information, and therefore, the SV 100 obtains association of a combination of the MAC address of the transmission source VM and the MAC address of the destination VM with a route allocated to the combination using the hashing operation. Thus, even without knowing details of the hashing operation executed by the RBs 1 to 7, it may be determined which MAC address is to be set for a packet and accordingly which route is to be selected by the hashing operation.

Step 421 of obtaining sampling information from each of the SVs 101 to 108 is executed by the sampling information obtaining section 411. The sampling information includes at least the MAC address of the transmission source VM, the MAC address of the destination VM, an Internet Protocol (IP) address of the transmission source VM, an IP address of the destination VM, and a payload as a transmission target. Also, the sampling information includes at least the MAC address of an RB that is to be a destination or the MAC address of an RB that is to be a transmission source. The sampling information is information obtained by sampling performed by the vSWs 21 to 28 on data transferred from the corresponding VNs 11 to 18 and then transferring the sampled data to the SV 100. Step 422 of selecting a combination of the transmission source address and the destination address from the sampling information is executed by the conversion address extraction section 412. By Step 422, the SV 100 selects a combination of the transmission source VM and the destination VM that are executing data transfer via the network 1000. Note that Step 420 may be executed after Step 421 or Step 422.

Step 423 of extracting a prospective conversion address is executed by the conversion address extraction section 412. In Step 422, for the MAC address of the transmission source VM and the MAC address of the destination VM selected on the basis of the sampling information, a combination of the MAC addresses which have a history in which, in the network 1000, at least the same edge RBs and different routes have been selected is determined on the basis of the log information obtained in Step 420. The determined combination of the MAC addresses is a prospective combination for address conversion performed to the MAC addresses of the transmission source VM and the MAC address of the destination VM that have been selected. For example, in the case where data transfer from the selected transmission source VM to the selected destination VM is executed via a route in which congestion has occurred, if address conversion is performed using the determined combination of the MAC addresses, data transfer to the edge RB bypassing the route in which the congestion has occurred is ensured, so that data is transmitted through to the destination VM.

Step 424 of storing the prospective conversion address as the address conversion information is executed by the conversion address extraction section 412. By Step 424, the conversion address is stored in the memory 401. When processing illustrated in FIG. 14 is executed before congestion occurs in the network 1000, the prospective conversion address is stored in the memory 401 in advance. Note that the address conversion information is information illustrated in FIG. 15, and the details of which will be described later.

Step 425 of determining whether or not there is any other combination of addresses in the sampling information is executed by the conversion address extraction section 412. In Step 425, if it is determined that there is another combination of addresses in the sampling information, the process proceeds to Step 422. If no prospective conversion address is extracted for the combination of the transmission source VM and the destination VM that are executing data transfer via the network 1000, processing is continued by Step 425 so that a prospective conversion address is obtained. As described above, the processing illustrated in FIG. 14 is executed, and thus, the SV 100 obtains the address conversion information illustrated in FIG. 15.

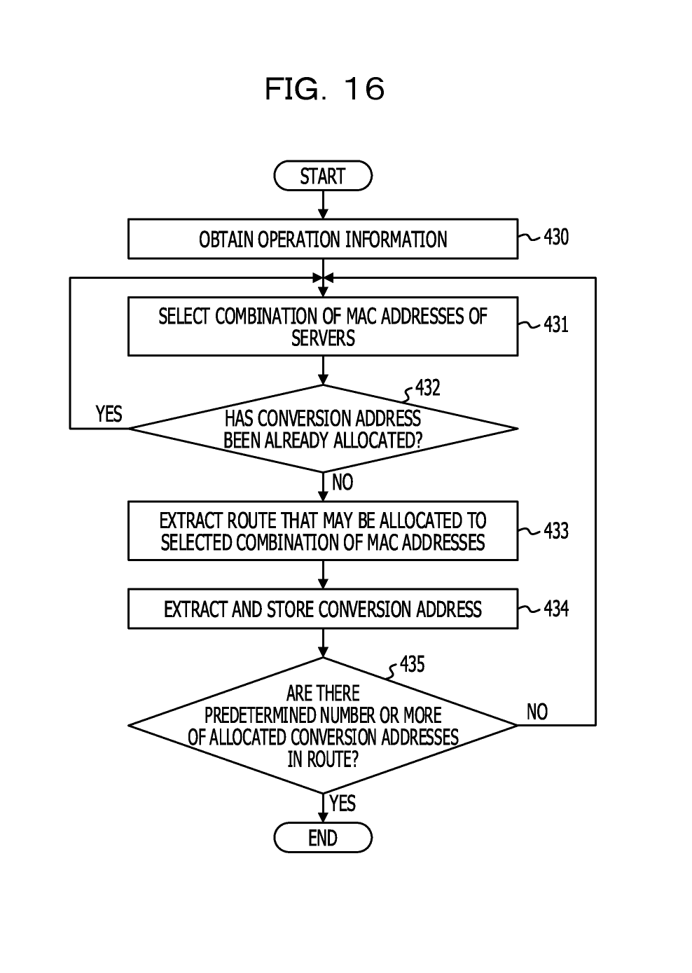

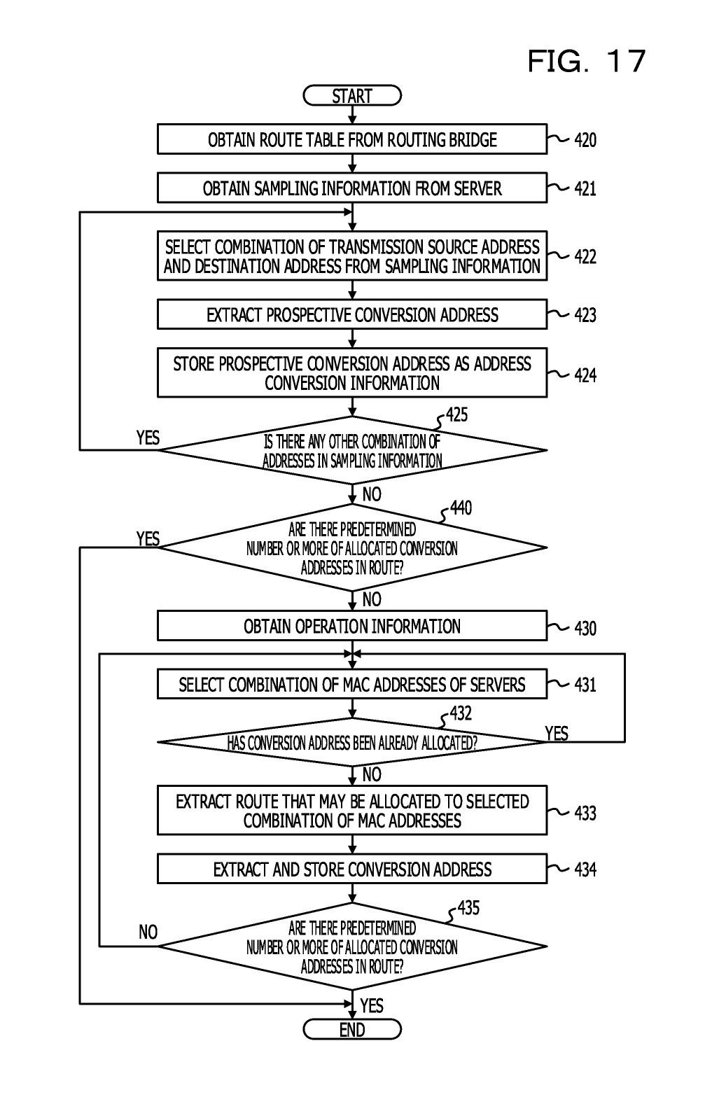

FIG. 15 illustrates the address conversion information according to the embodiment. The address conversion information is stored in the memory 401 as a result of the processing illustrated in FIG. 14, or processing illustrated in FIG. 16 or FIG. 17, which will be described later. For example, for the combination of the MAC addresses whose IDs are identified by “1” and “2,” as prospective conversion addresses for the combination of “00-90-27-AA-74-E0” and “00-90-27-AA-90-E0,” a combination of “00-90-27-BB-86-E2” and “00-90-27-BB-20-E2” is illustrated as an example. As described above, the prospective conversion addresses are a combination of the MAC addresses with which at least the same edges RB and different routes are selected in the network 1000 for the addresses before the conversion. Therefore, when congestion occurs, the route in which the congestion has occurred may be bypassed, by converting the MAC addresses to the prospective conversion addresses illustrated in FIG. 15, without changing the algorithm (route selection using the total link cost and the hashing operation) set for the RBs 1 to 7, and thus, the congestion may be recovered.

FIG. 16 illustrates another processing executed by the management server to which the embodiment is applied. The processing illustrated in FIG. 16 is another example performed to cause the SV 100 to obtain the address conversion information illustrated in FIG. 15.

Step 430 of obtaining operation information is executed by the operation information obtaining section 413. By Step 430, the SV 100 obtains the operation information used for route selection for data transfer from the RBs 1 to 7. For example, the SV 100 obtains the hash coefficient in the hashing operation used for route selection for data transfer from the RBs 1 to 7.

Step 431 of selecting a combination of the MAC addresses of servers is executed by the conversion address extraction section 412. By Step 431, a combination of virtual machines that are to be executed in the SVs 101 to 108 is selected. For example, using the sampling information obtained from the SVs 101 to 108, a combination of the MAC address of the transmission source VM and the MAC address of the destination VM may be obtained, and thus, the combination of the virtual machines may be selected.

Step 432 of determining whether or not the conversion address has been already allocated to the selected combination of the MAC addresses in Step 431 is executed by the conversion address extraction section 412. If it is determined by referring to the memory 401 and the like that the conversion address has been already allocated, the process proceeds to Step 431. If the conversion address has not been allocated, the process proceeds to Step 433.

Step 433 of extracting a route that may be allocated to the selected combination of the MAC addresses is executed by the conversion address extraction section 412. By Step 433, a route via RBs corresponding to the selected combination of the MAC addresses is extracted.

Step 434 of extracting and storing the conversion address for the extracted route in Step 433 is executed by the conversion address extraction section 412. By Step 430, the SV 100 obtains the hash coefficient with which the RBs 1 to 7 are used for route selection. The SV 100 calculates on the basis of the obtained hash coefficient which MAC address is to be used as a variant of the hashing operation of the RBs 1 to 7 to select the route extracted in Step 433, and extracts the calculated MAC address as the conversion address. The extracted conversion address is stored in the memory 401 as the address conversion information of FIG. 15.

Step 435 of determining whether or not there are a given number or more of allocated conversion addresses in a route is executed by the conversion address extraction section 412. If there are not the given number or more of allocated conversion addresses in a route, the process proceeds to Step 431 and, if there are the given number or more of allocated conversion addresses in the route, the process is ended. By allocating a plurality of prospective conversion addresses in a single route, the number of combinations of virtual machines that are allocated to a particular route may be made a plural number.

FIG. 17 illustrates another processing executed by the management server (SV 100) to which the embodiment is applied. The same steps as those illustrated in FIGS. 14 and 16 are identified by the same reference numerals and the description thereof will be omitted. In the processing illustrated in FIG. 17, the address conversion information is obtained by executing the processing illustrated in FIG. 14. On the basis of the obtained address conversion information, Step 440 of determining whether or not the given number or more of allocated conversion addresses in a route is executed. If there are not the given number or more of allocated conversion addresses in a route, the process illustrated in FIG. 16 is executed. When extraction of the conversion address is performed on the basis of analysis of the hash coefficient, a processing load of the SV 100 is larger than a processing load of the SV 100 caused when extraction of the conversion address is performed on the basis of the log information. Therefore, after extraction of the conversion address using the log information as illustrated in FIG. 14, if the number of allocated conversion addresses in a route is smaller than the given number, extraction of the conversion address on the basis of the analysis of the hash coefficient is executed as illustrated in FIG. 16, and thus, the conversion address is efficiently extracted while the processing load of the SV 100 is reduced.

FIG. 18 illustrates another functional block of the management server (SV 100) to which the embodiment is applied. By executing the program stored in the memory 401 by the CPU 400, the SV 100 functions as a sampling information obtaining section 411, a transfer information obtaining section 414, congestion determination section 415, a traffic analysis section 416, congestion flow determination section 417, an alternative route selection section 418, and an address setting section 419. Processing executed by each functional block will be described in correspondence with processing illustrated in FIG. 19.

FIG. 19 illustrates another processing executed by the management sever to which the embodiment is applied. Step 450 of extracting the conversion address is executed by the SV 100. In Step 450, the processing illustrated in FIGS. 14, 16, and 17 may be used. Note that Step 450 may be executed after Step 451.

Step 451 of determining whether or not congestion has occurred in the network 1000 is executed by the SV 100. For example, the transfer information obtaining section 414 obtains as transfer information the amount of data stored in the input buffer or the output buffer included in the transmission and reception interfaces of each of the RBs 1 to 7 or information regarding a free space of the input buffer or the output buffer, and stores the transfer information in the memory 401. The congestion determination section 415 determines, on the basis of the obtained transfer information, whether or not the amount of data stored in the input buffer or the output buffer of each of the RBs 1 to 7 exceeds a given amount, or whether or not the free space of the input buffer or the output buffer is less than a given amount, thereby determining whether or not congestion has occurred in the network 1000. For example, when detecting the amount of data of the input buffer of the RB 3 which stores data from the RB 5 exceeds the given amount on the basis of the transfer information, the congestion determination section 415 determines that congestion has occurred in the link LK10 as connection between the RB 3 and the RB 5. Note that a cause for the occurrence of congestion is that a request for transferring data equivalent to or greater than an actual bandwidth of a link is made. Therefore, not only when the traffic amount of transfer data is large but also even when the traffic amount of transfer data in one switch is small and there are sufficient free spaces in the input buffer and output buffer, congestion might occur if the link bandwidth of the other switch in the route is small, as compared to the transfer data.

When it is determined in Step 451 that congestion has occurred, Step 452 of specifying a flow (a combination of the transmission source address and the destination address) with which data is transferred via the route in which the congestion has occurred is executed by the SV 100. For example, the traffic analysis section 416 analyzes, on the basis of the sampling information obtained from the SVs 101 to 108 by the sampling information obtaining section 411, the traffic amount (flow rate) of data for each combination of the transmission source VM and the destination VM. For example, the traffic analysis section 416 specifies, on the basis of the MAC address of the transmission source VM and the MAC address of the destination VM included in the sampling information, a combination of the transmission source VM and the destination VM. The traffic amount is obtained by analyzing the amount of data per unit time for each specified combination of the transmission source VM and the destination VM. Note that, since the processing load of the SV 100 is increased by analysis of the traffic amount, analysis of the traffic amount may be executed using the determination of the occurrence of congestion as a trigger. The congestion flow determination section 417 specifies, on the basis of the traffic amount of each combination of the transmission source VM and the destination VM and the route table obtained from the RBs 1 to 7, a flow which is executing data transfer via the link in which the congestion has occurred. Step 453 of selecting an alternative route for the flow specified by Step 452 is executed by the SV 100. For example, the alternative route selection section 418 specifies, on the basis of the MAC address of the transmission source VM and the MAC address of the destination VM in the specified flow, and selects an alternative route from routes in which congestion has not occurred.

Step 454 of selecting a conversion address corresponding to the selected alternative route is executed by the address setting section 419. The conversion address may be selected on the basis of the address conversion information extracted by Step 450. For example, if it is determined that the combination of the MAC address of the transmission source VM and the MAC address of the destination VM included in the address conversion information is not performing communication, the combination of the MAC address of the transmission source VM and the MAC address of the destination VM may be selected as the conversion address.

Step 455 of setting the conversion address for a server which is executing data transfer via a route in which congestion has occurred is executed by the address setting section 419. By Step 455, the conversion address is stored in the memory 501 of a corresponding server among the SVs 101 to 108. Note that, if the address conversion information is stored in the memory 501 of the corresponding server among the SVs 101 to 108, even when the SV 100 goes down, communication in which the route in which the congestion has occurred is bypassed may be continued. Then, Step 456 of determining whether or not monitoring of the network 1000 is to be continued is executed by the SV 100.

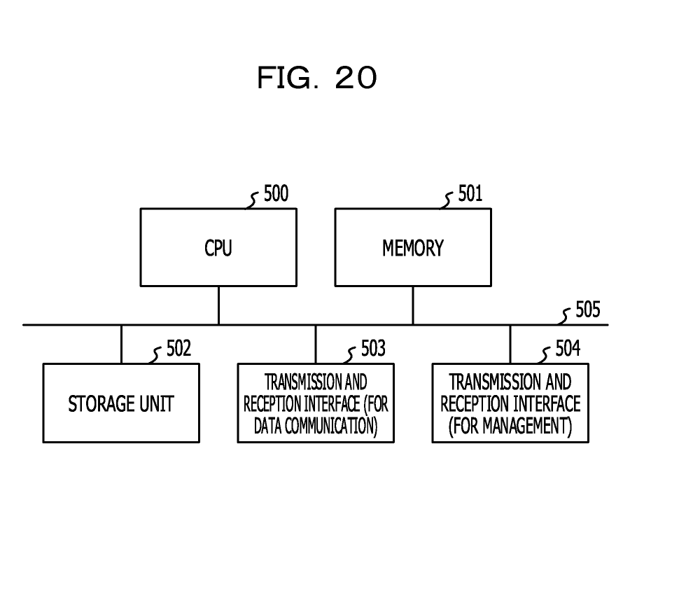

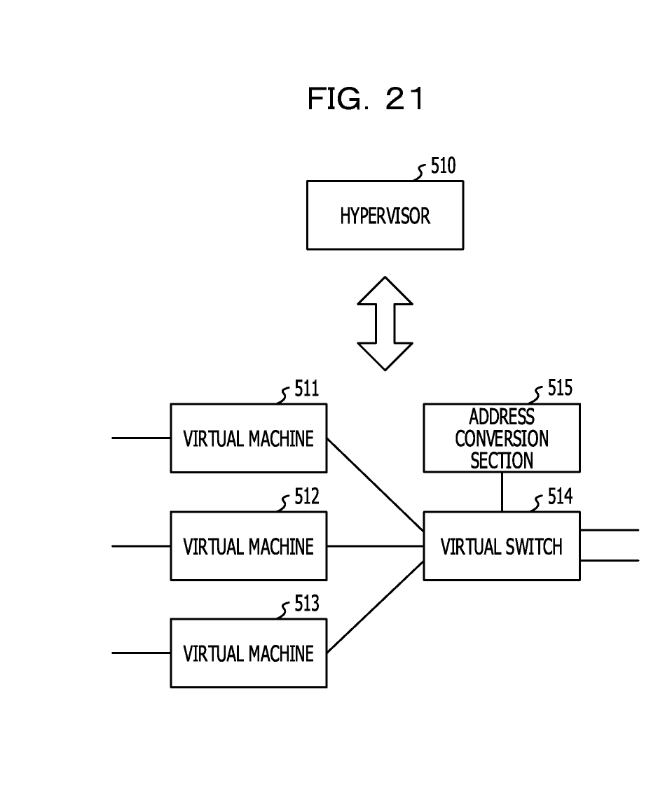

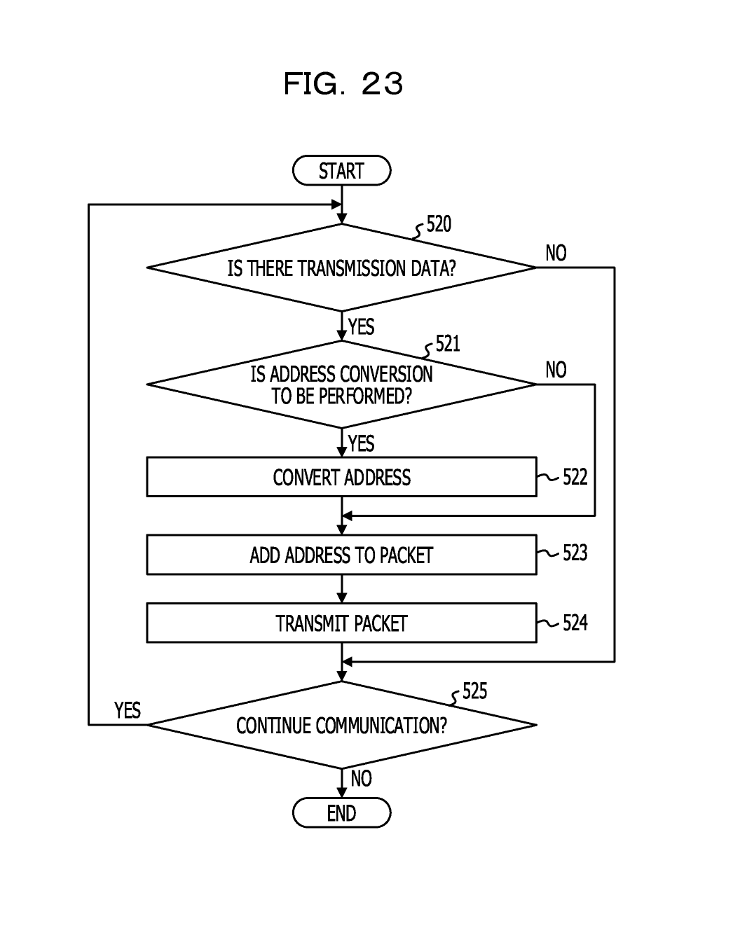

FIG. 20 illustrates a hardware configuration for the servers (the SVs 101 to 108) to which the embodiment is applied. Each of the SVs 101 to 108 is a computer including a CPU 500, a memory 501, a storage unit 502, a transmission and reception interface (for data communication) 503, a transmission and reception interface (for management) 504, and a bus 505 to which these components are connected. The CPU 500 includes one or more processors that execute processing. The memory 501 is, for example, a RAM. The storage unit 502 is, for example, a nonvolatile memory such as a ROM, a flash memory, and so forth, or a magnetic disk such as a hard disk drive (HDD) and so forth. The transmission and reception interface (for data communication) 503 is an interface used for transmitting and receiving data to and from an external apparatus. The transmission and reception interface (for management) 504 is an interface used for transmitting and receiving data used for management. A program in which processing that controls the operation of each of the SVs 101 to 108 is written and a program in which processing illustrated in FIGS. 23 to 26 is written are stored in the memory 501. By executing the programs stored in the memory 501 by the CPU 500, the operations of the SVs 101 to 108 are controlled, and the SVs 101 to 108 function as functional blocks illustrated in FIG. 21.

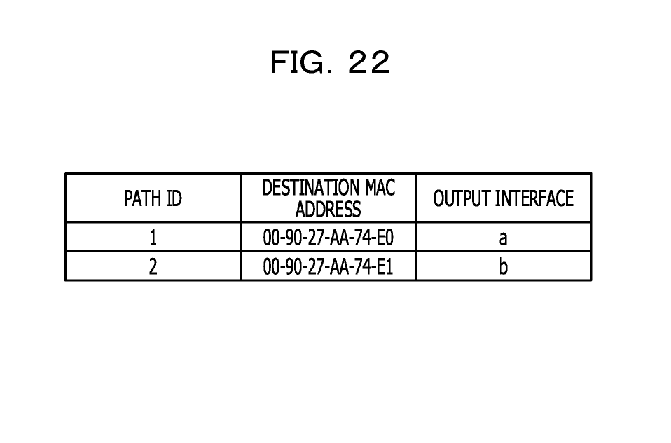

FIG. 21 illustrates a functional block for the servers (the SVs 101 to 108) to which the embodiment is applied. By executing the programs stored in the memory 501 by the CPU 500, the SVs 101 to 108 function as a hypervisor 510, virtual machines 511 to 513, a virtual switch 514, and an address conversion section 515. The hypervisor 510 has a function of performing management on an entire server of itself. Also, the hypervisor 510 has a function of performing allocation of a virtual address to a network interface and migration (live migration) of the virtual machines 511 to 513. The virtual machines 511 to 513 correspond to the above-described VMs 11 to 18 and are softwares configured to emulate the operation of a computer. The virtual switch 514 corresponds to the vSW 21 to 28 and so forth and has a function of controlling data transfer between the virtual machines 511 to 513 and the network interface in accordance with the route table illustrated, for example, in FIG. 22. The address conversion section 515 converts an address given in a packet in the virtual switch on the basis of the conversion address set by the SV 100.

FIG. 22 illustrates a route table included in the virtual switches of the servers (the SVs 101 to 108) to which the embodiment is applied. The route table is information used for associating the network interface with the virtual machines on the basis of the transmission source MAC address and the destination MAC address. For example, the destination MAC address “00-90-27-AA-74-E0” is associated with an output interface identified by “a.”

FIG. 23 illustrates transmission processing executed in the virtual switches of the servers (the SVs 101 to 108) to which the embodiment is applied. When it is determined by Step 520 that there is transmission data, Step 521 of determining whether or not the address conversion is to be performed is executed. When it is determined that the MAC address allocated to the VM which transmits data is the MAC address that is to be converted to the conversion address set by the SV 100, an address given in the packet is converted by execution of Step 522 by the address conversion section 515, and the process proceeds to Step 523. By Step 523, the MAC address on the basis of Steps 521 and 522 are added to the packet on the basis of the transmission data, and the packet is transmitted by Step 524. In Step 525, whether or not communication is to be continued is determined.

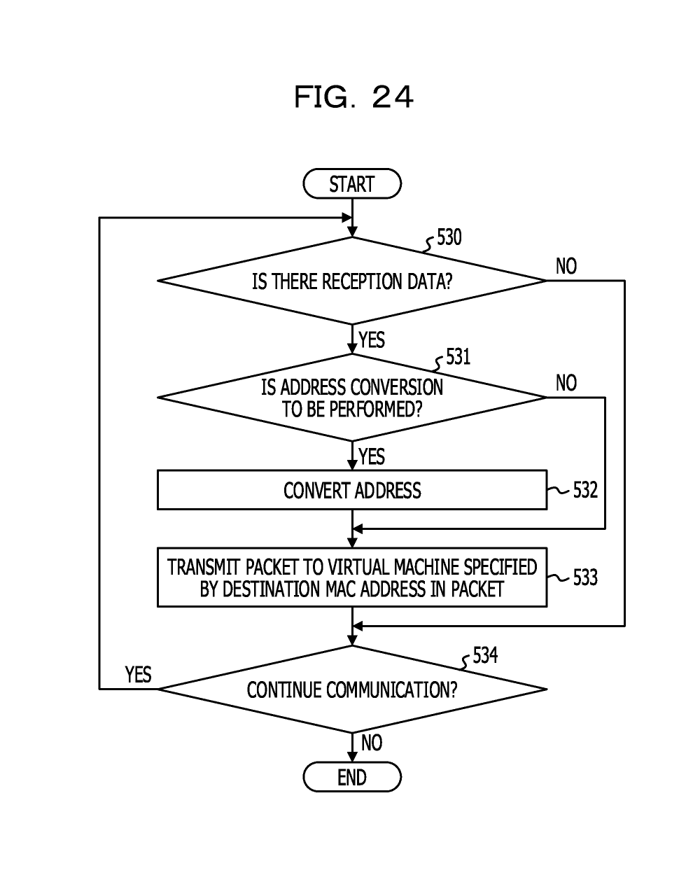

FIG. 24 illustrates reception processing executed in the virtual switches of the servers (the SVs 101 to 108) to which the embodiment is applied. When it is determined by Step 530 that there is reception data, Step 531 of determining whether or not address conversion is to be performed is executed. When it is determined that the MAC address included in the packet is the MAC address to which the conversion address set by the SV 100 is applied, the MAC address is converted by execution of Step 532 by the address conversion section 515, and the process proceeds Step 533. By Step 533, the packet is transmitted to the VM corresponding to the MAC address on the basis of Steps 531 and 532. In Step 534, whether or not communication is to be continued is determined.

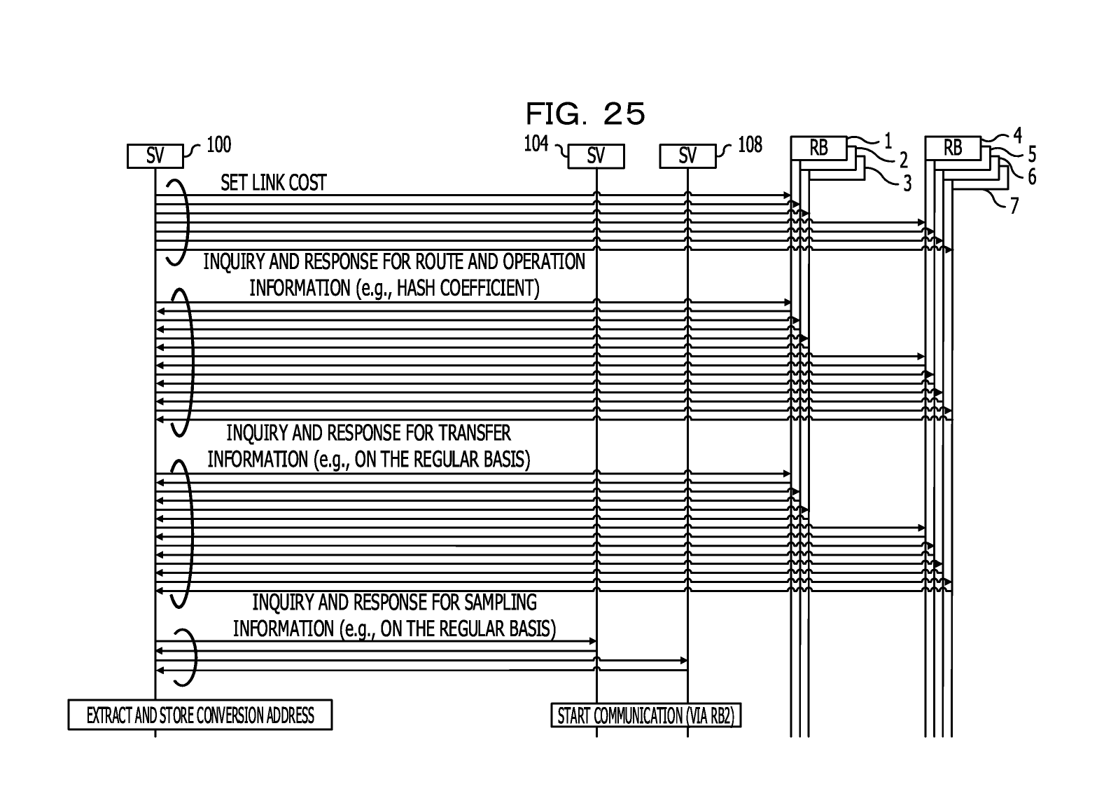

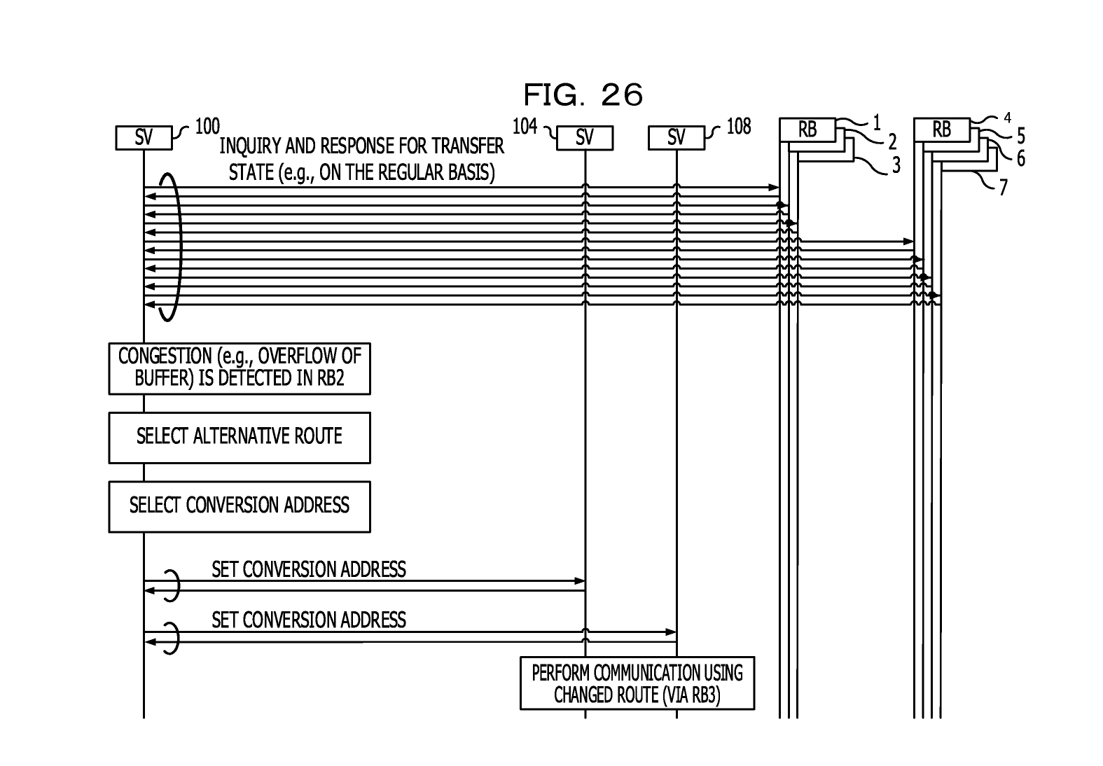

FIGS. 25 and 26 illustrate an example of the information processing system to which the embodiment is applied. In this example, a case where congestion occurs in a route in which data transfer from the SV 104 to the SV 108 is performed is illustrated.

As illustrated in FIG. 25, the SV 100 sets a link cost to each of the RBs 1 to 7. On the basis of the set link costs, the RBs 1 to 7 execute Step 320 to create cost information (see, for example, FIGS. 5 and 6). The SV 100 executes an inquiry for a route and operation information on the RBs 1 to 7. As a response to the inquiry, the RBs 1 to 7 notify the SV 100 of the log information including the association of combinations of the MAC address of the transmission source VM and the MAC address of the destination VM with routes as the route information or the hash coefficient used for the hashing operation applied in route selection as the operation information. The SV 100 executes an inquiry for the transfer information on the RBs 1 to 7. As a response to the inquiry, the RBs 1 to 7 provides information obtained by the transfer information monitoring section 315 as the transfer information in order to notify the SV 100 of congestion state in the network 1000. Note that the inquiry of the transfer information may be executed using a simple network management protocol (SNMP) which is a protocol used for obtaining management information base (MIB) information, and information obtaining using the SNMP may be executed on a regular basis. The SV 100 executes an inquiry for the sampling information on the SVs 101 to 108. Note that the description will focus on the SV 104 and the SV 108. As a response to the inquiry, the SV 104 and the SV 108 notify the SV 100 of the sampling information including at least the MAC address of a transmission source virtual machine, the MAC address of a destination virtual machine, the Internet protocol (IP) address of the transmission source virtual machine, the IP address of the destination virtual machine, data that is to be a transmission target, and the MAC address of an RB that is to be a destination or the MAC address of an RB that is to be a transmission source. Note that the inquiry of the sampling information may be executed on a regular basis. The SV 100 extracts the conversion address by the processing illustrated in FIG. 14, 16, or 17 and stores the extracted conversion address in the memory 501. Note that the SV 104 and the SV 108 perform data transfer via the RB 5, the RB 2, and the RB 7.

As illustrated in FIG. 26, the SV 100 executes an inquiry for the transfer information again on the RBs 1 to 7. In this case, it is assumed that any one of responses of the RBs 1 to 7 includes information indicating that congestion has occurred in a link connected to the RB 2. On the basis of a result of the inquiry, the SV 100 executes the processing illustrated in FIG. 19, thereby detecting the congestion of the link connected to the RB 2 and selecting a route as an alternative route via the RB 5, the RB 3, and the RB 7. When the RBs 1 to 7 relay data transfer from the SV 104 to the SV 108, the SV 100 selects a conversion address with which a route extending via the RB 5, the RB 3, and the RB 7 is selected, and sets the conversion address to each of the SV 104 and the SV 108. Since the conversion address is set, the SV 104 changes the MAC address to be included in a packet when data is transferred from the allocated MAC address to the MAC address set by the SV 100, and the packet is transmitted to the RB 5. When the hashing operation is performed on the basis of the MAC address included in the packet, since the RB 3 has been converted to an address that is to be selected as the next transmission destination as a result of the hashing operation, the RB 5 sets the RB 3 as the next transmission destination, encapsulates data as illustrated in FIG. 8B, and transmits a packet. Then, the RB 3 transmits the packet to the RB 7, and the RB 7 determines that the next destination is the SV 108 and transmits a packet to the SV 108. The SV 108 determines that the MAC address in the received packet is a MAC address as a conversion target set by the SV 100, and converts the MAC address. The SV 108 transmits a packet to a virtual machine corresponding to the converted MAC address. Note that, for the MAC address that is to be converted by the SV 100, when the RBs 1 to 7 perform the hashing operation, the route may be changed without the edge RB being not changed, and thus, the MAC address of the transmission source VM or the MAC address of the destination VM included in the packet, or both of the MAC address of the transmission source VM and the MAC address of the destination VM may be a target. Moreover, the embodiment has been described using the hashing operation as an example, but the algorithm used for selecting a route is not limited to the hashing operation. Even using a different algorithm from the hashing operation, as long as the algorithm with which a route is determined on the basis of the MAC address of the transmission source VM and the MAC address of the destination VM is used, the above-described processing may be executed on the basis of the algorithm to convert the address such that another route is selected without changing the destination.

In the case where a plurality of routes are selected in a random manner or in the case where a round-robin method is applied and thus a plurality of routes are selected at the same frequency, if a data flow (a collection of series of data flowing between specific VMs) that is to be transmitted is divided and is transmitted in units of packets, a different route is allocated for each packet. When a different route is allocated for each packet, a route extending to the destination varies for each packet. Therefore, if there is a difference in communication time among different routes, the order of packets when the packets are received at the destination might be different from the order of the packets when the packets are transmitted.

Note that, even when the data flow that is to be transmitted is divided for each packet, as long as the transmission source and the destination are the same, the transmission source address and the destination address included in each packet are the same. Then, if a route is allocated in accordance with a combination of the transmission source address and the destination address included in the packet, each packet is transmitted to the destination via the same route. In this case, reverse of the packet order is not caused and selected routes diverge in accordance with the combination of the addresses, and thus, the network load of the network is decentralized.

However, with a route allocated in accordance with the combination of the addresses, even when congestion occurs in the network, the route in which the congestion has occurred is continuously allocated to the combination of the addresses which are performing communication via the route in which the congestion has occurred, and thus, the congestion is not recovered.

According to the above-described embodiment, when congestion occurs in a network in which a route is selected using an operation on the basis of an address in a packet, the address in the packet is changed such that the destination is not change, and thus, the route in which the congestion has occurred is bypassed without changing an algorithm used in an operation performed for selecting a route to recover the congestion.

Also, changing a setting for the RBs 1 to 7 in order to bypass a route in which congestion occurs will be hereinafter discussed. For example, when a setting provided for fixing a route to a combination of a transmission address and a destination address included in a received packet is applied to the RBs 1 to 7, a setting provided for selecting a specific route is performed to all of the RBs 1 to 7 each time a request for route change is made. Also, when the number of servers or the number of virtual machines executed in servers increases, there might be cases where setting change depending on the number is performed, and therefore, it is difficult to perform a realistic operation. Moreover, when the virtual machine is shifted to another server by live migration, there might be cases where, even when the MAC address of the virtual machine is not changed, the corresponding edge RB is changed. In that case, a setting provided for selecting a specific route is performed again on all of the RBs 1 to 7.

According to the embodiment, route change to a specific route may be allowed by address conversion at the server side. When a communication route is constructed by a relay apparatus to which the hashing operation of the MAC address is applied such that the order of packets is not changed in a network configured in accordance with a design concept in which a decentralized control protocol such as a link cost is introduced in order to decentralize a communication load, it is effective in view of effectively utilizing a resource of the network to change data transfer to a specific route by address conversion at the server side, even if change of the decentralized control protocol and change of setting for a relay apparatus are not performed. Also, in a situation where live migration of a virtual machine occurs, or in the case where the number of virtual machines increases, setting change for a corresponding server may be performed. Furthermore, even in the case where congestion has not occurred, a specific route is allocated for data transfer using a bandwidth by applying the embodiment. Thus, congestion is not caused even when change of the decentralized control protocol and change of setting for a relay apparatus are not performed. Furthermore, according to the embodiment, the MAC address is converted such that a specific route is not used. Thus, use of a specific relay apparatus is reduced, and energy saving for the network is achieved. Moreover, according to the embodiment, conversion of the MAC address is performed such that data transfer is allocated to a route other than a route in accordance with a decentralized control algorithm set by the relay apparatus. Thus, data transfer is further decentralized, and effective use of a network resource is realized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing system comprising:
a relay apparatus configured to select a first route by an operation on the basis of a first address in a packet; and
a computer configured to change, when congestion occurs in the first route, an address in the packet from the first address to a second address which causes the relay apparatus to select a second route having a destination the same as that of the first route by the operation.

2. The information processing system according to claim 1,
wherein the second address is an address set on the basis of log information including association of a route selected by the operation with an address in a packet.

3. The information processing system according to claim 2,
wherein the operation is a hashing operation on the basis of an address in a packet that is to be received by the relay apparatus, and
a third address which causes the relay apparatus to select the second route that is different from the first route by the hashing operation is set on the basis of a hash coefficient of the hashing operation.

4. The information processing system according to claim 1,
wherein the first address is a physical address allocated to a computer that is to be a transmission source for a network including the relay apparatus, a physical address allocated to a computer that is to be a destination for the network, or a combination of the physical addresses.

5. The information processing system according to claim 1,
wherein the operation is a hashing operation on the basis of an address in a packet that is to be received by the relay apparatus, and
the second address is an address set on the basis of a hash coefficient of the hashing operation.

6. The information processing system according to claim 1,
wherein the second address is set by the computer before congestion occurs in the first route.

7. The information processing system according to claim 1,
wherein the relay apparatus selects, when there are a plurality of selectable routes, a transfer route from the selectable routes by the operation.

8. The information processing system according to claim 7,
wherein the relay apparatus selects the plurality of selectable routes on the basis of a parameter set for a route in order to select the route.

9. An information processing method comprising:
selecting a first route by an operation on the basis of a first address in a packet; and
changing, when congestion occurs in the first route, an address in the packet from the first address to a second address which causes the relay apparatus which has selected the first route to select a second route having a destination the same as that of the first route by the operation.

10. The information processing method according to claim 9, wherein
the second address is an address set on the basis of log information including association of a route selected by the operation with an address in a packet.

11. The information processing method according to claim 10, wherein
the operation is a hashing operation on the basis of an address in a packet that is to be received by the relay apparatus, and
the information processing method comprises setting, on the basis of a hash coefficient of the hashing operation, a third address which causes the second route that is different from the first route to be selected by the hashing operation.

12. The information processing method according to claim 9, wherein
the first address is a physical address allocated to a computer that is to be a transmission source, a physical address allocated to a computer that is to be a destination, or a combination of the physical addresses.

13. The information processing method according to claim 9, wherein
the operation is a hashing operation on the basis of an address in a packet that is to be received by the relay apparatus, and the second address is an address set on the basis of a hash coefficient of the hashing operation.

14. The information processing method according to claim 9, wherein
the second address is set before congestion occurs in the first route.

15. A relay apparatus comprising:
a memory which stores a program; and
a processor which executes, on the basis of the program, a procedure comprising:
executing, when congestion occurs in the first route selected by an operation on the basis of a first address in a packet, the operation on the basis of a second address which causes a second route having a destination the same as that of the first route to be selected by the operation.
